(19) United States
(12) Patent Application Publication
(10) Pub. No.: US 2022/0214910 A1
(43) Pub. Date: Jul. 7, 2022

(54) INFORMATION PROCESSING SYSTEM, INFORMATION PROCESSING APPARATUS, AND INFORMATION PROCESSING METHOD

(71) Applicant: Tadashi HONDA, Kanagawa (JP)

(72) Inventor: Tadashi HONDA, Kanagawa (JP)

(21) Appl. No.: 17/539,211

(22) Filed: Dec. 1, 2021

(30) Foreign Application Priority Data
Jan. 7, 2021 (JP) 2021-001747

(51) Int. Cl. G06F 9/48; G06F 16/23

(52) U.S. Cl. CPC G06F 9/4843; G06F 16/2379

(57) ABSTRACT

A worker processor includes worker circuitry that: acquires a particular job of the plurality of jobs from the message queue; and determines whether the particular job is in the error status; and based on a determination that the particular job is in the error status, returns the particular job to the message queue based on a determination that: the error has been occurred in executing of the particular job by one or more of the plurality of worker processors, other than the particular worker processor, at the particular worker server; and a job type of the particular job in the error status is the same job type assigned to the particular worker processor.

### CROSS-REFERENCE TO RELATED APPLICATIONS

This patent application is based on and claims priority pursuant to 35 U.S.C. § 119(a) to Japanese Patent Application No. 2021-001747, filed on Jan. 7, 2021, in the Japan Patent Office, the entire disclosure of which is hereby incorporated by reference herein.

### BACKGROUND

### Technical Field

The present disclosure relates to an information processing system, an information processing apparatus, and an information processing method.

### Related Art

There is known a technique of distributed processing. In the distributed processing, jobs such as document processing for converting an image to a portable document format (PDF) are distributed to and executed by a plurality of worker processors of a worker server. Hereinafter, a worker processor is referred to as a worker as an example of an information processing apparatus.

### SUMMARY

Embodiments of the present disclosure provide an information processing system, an information processing apparatus, and an information processing method.

The information processing system includes: a shared file storage area that stores, for each of a plurality of jobs, a processing subject file of the job and a processing result file of the job; a job information management database that stores, for each of the plurality of jobs, job information of the job and a status of the job; one or more servers including circuitry that receives an execution request of the job from a front-end application, stores the job information of the job in the job information management database, and stores the job in a message queue; and one or more worker servers including a particular worker server, the particular worker server including a plurality of worker processors, the plurality of worker processors including a particular worker processor including worker circuitry that: acquires a particular job of the plurality of jobs from the message queue; and determines whether the particular job is in an error status, and based on a determination that the particular job is in the error status, the worker circuitry that further: returns the particular job to the message queue based on a determination that: an error has been occurred in executing of the particular job by one or more of the plurality of worker processors, other than the particular worker processor, at the particular worker server; and a job type of the particular job in the error status is the same job type assigned to the particular worker processor.

The information processing apparatus including a plurality of worker processors including a particular worker processor, the particular worker processor including worker circuitry that: acquires a particular job of a plurality of jobs from a message queue; determines whether the particular job is in an error status; and based on a determination that the particular job is in the error status, the worker circuitry that further: returns the particular job to the message queue based on a determination that: an error has been occurred in executing of the particular job by one or more of the plurality of worker processors, other than the particular worker processor, at the information processing apparatus; and a job type of the particular job in the error status is the same job type assigned to the particular worker processor.

The information processing method, performed by a worker processor, includes: acquiring a particular job of a plurality of jobs from a message queue; determining whether the particular job is in an error status; and based on a determination that the particular job is in the error status, the method further includes: returning the particular job to the message queue based on a determination that: an error has been occurred in executing of the particular job by one or more of a plurality of worker processors, other than a particular worker processor, at the information processing apparatus; and a job type of the particular job in the error status is the same job type assigned to the particular worker processor.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A is a block diagram illustrating an example of a hardware configuration of various servers included in an information processing system according to a first embodiment of the present disclosure;

FIG. 1B is a block diagram illustrating an example of a functional configuration of the information processing system according to the first embodiment;

FIG. 2 is a block diagram illustrating an example of a configuration of the servers in the information processing system according to the first embodiment;

FIG. 3 is a table illustrating an example of a data configuration of a job information table in the information processing system according to the first embodiment;

FIG. 4 is a table illustrating an example of a data configuration of a task status table in the information processing system according to the first embodiment;

FIG. 5 is a sequence diagram illustrating an example of a sequence of processing for executing a job in the information processing system according to the first embodiment;

FIG. 6 is a sequence diagram illustrating an example of a sequence of processing for returning an assigned job to a queue of a message queue in the information processing system according to the first embodiment;

FIG. 7 is a sequence diagram illustrating an example of a sequence of processing for executing the assigned job by a worker in the information processing system according to the first embodiment;

FIG. 8 is a schematic diagram illustrating an example of processing for returning an assigned job to a queue of a message queue by a worker in an information processing system according to a second embodiment of the present disclosure;

FIG. 9 is a sequence diagram illustrating an example of a sequence of processing for executing a job in an information processing system according to a third embodiment of the present disclosure;

FIG. 10 is a table illustrating an example of a data configuration of an error information table included in a job information table of an information processing system according to a fourth embodiment of the present disclosure;

FIG. 11 is a sequence diagram illustrating an example of a sequence of processing for executing the job in the information processing system according to the fourth embodiment; and

FIG. 12 is a sequence diagram illustrating an example of a sequence of processing for executing an assigned job for a test file in an information processing system according to a fifth embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a detailed description is given of several embodiments of an information processing system, an information processing apparatus, and an information processing method, with reference to the drawings.

### First Embodiment

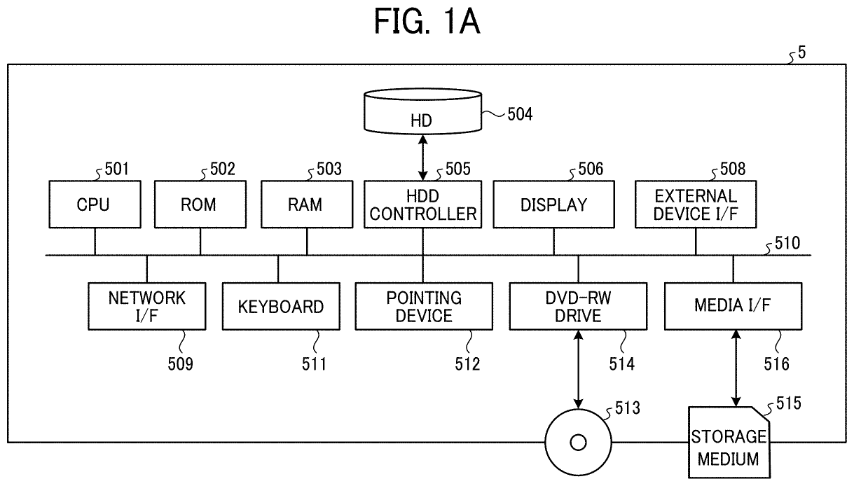

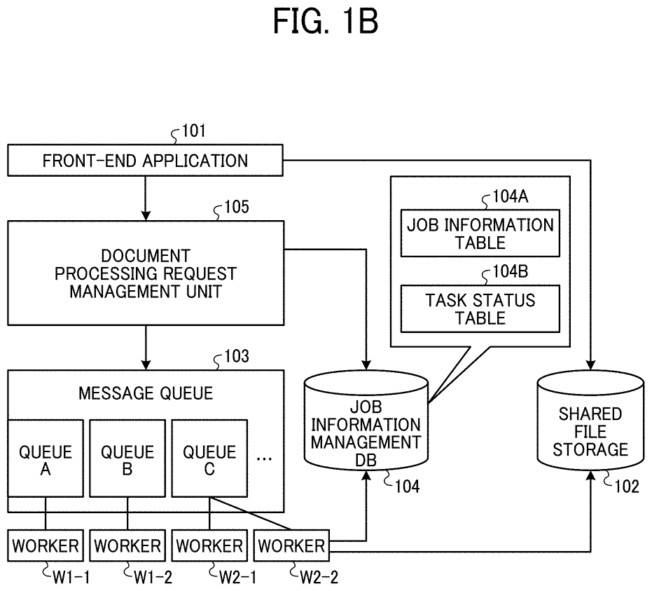

FIG. 1A is a block diagram illustrating an example of a hardware configuration of various servers included in an information processing system according to a first embodiment of the present disclosure. First, referring to FIG. 1A, a description is given of a hardware configuration of a server 5 as an example of various servers (an application server 201, a file server 202, a queue server 203, a database (DB) server 204, a front server 205, a worker server WS1, and a worker server WS2 in FIG. 2) included in the information processing system.

As illustrated in FIG. 1A, the server 5 is implemented by a processor. The server 5 includes a central processing unit (CPU) 501, a read only memory (ROM) 502, a random access memory (RAM) 503, a hard disk (HD) 504, a hard disk drive (HDD) controller 505, a display 506, an external device interface (I/F) 508, a network I/F 509, a bus line 510, a keyboard 511, a pointing device 512, a digital versatile disc rewritable (DVD-RW) drive 514, and a media I/F 516.

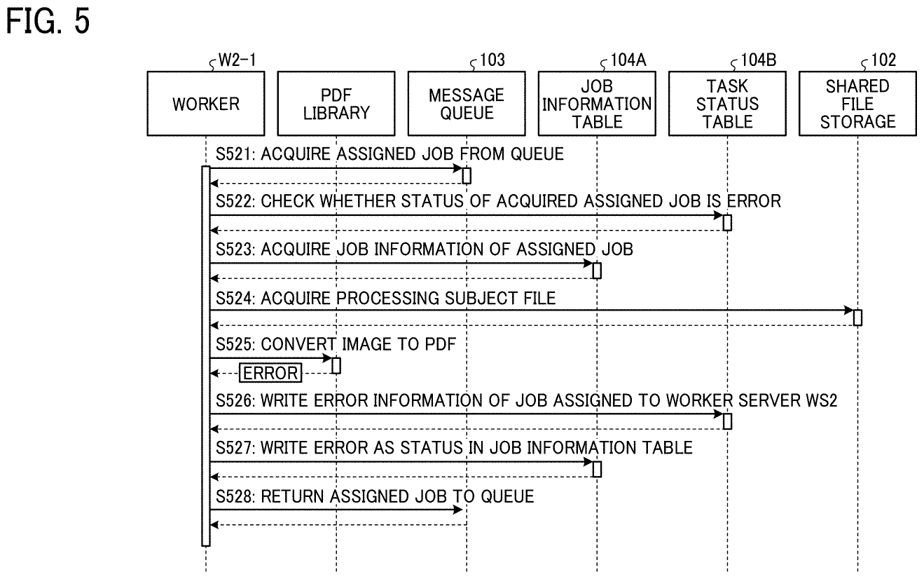

The CPU 501 controls an entire operation of the server 5. The ROM 502 stores programs such as an initial program loader (IPL) to boot the CPU 501. The RAM 503 is used as a work area for the CPU 501. The HD 504 stores various data such as a program. The HDD controller 505 controls reading and writing of various data to and from the HD 504 under control of the CPU 501. The display 506 displays various types of information such as a cursor, a menu, a window, characters, or an image. The external device I/F 508 is an interface that connects the server 5 to various external devices. Examples of the external devices include, but not limited to, a universal serial bus (USB) memory and a printer. The network I/F 509 is an interface for data communication through a communication network 100. The bus line 510 may be an address bus or a data bus, which electrically connects various elements such as the CPU 501 of FIG. 5.

The keyboard 511 is an example of an input device including a plurality of keys for inputting characters, numerical values, various instructions, and the like. The pointing device 512 is an example of an input device that allows a user to select or execute a specific instruction, select a subject for processing, or move a cursor being displayed. The DVD-RW drive 514 reads and writes various data from and to a DVD-RW 513, which is an example of a removable recording medium. The removable storage medium is not limited to the DVD-RW and may be a digital versatile disc-recordable (DVD-R) or the like. The media I/F 516 controls reading and writing (storing) of data from and to a storage medium (media) 515 such as a flash memory.

FIG. 1B is a block diagram illustrating an example of a functional configuration of the information processing system according to the first embodiment. The information processing system according to the present embodiment includes a front-end application 101, a shared file storage 102, a message queue 103, a job information management database 104, a document processing request management unit 105, and a plurality of worker processors W1-1, W1-2, W2-1, and W2-2. Hereinafter, a worker processor is referred to as a worker as an example of the information processing apparatus. In the following description, the workers W1-1, W1-2, W2-1, and W2-2 are collectively referred to as workers W unless particularly distinguished from each other.

The front-end application 101 is an application that requests execution of a job. The shared file storage 102 is a storage area that stores a file to be processed in a job (hereinafter referred to as a processing subject file) and a file of a processing result of the job (hereinafter referred to as a processing result file). The message queue 103 includes a queue in which jobs are queued.

The job information management database 104 is a database that stores a job information table 104A and a task status table 104B. The job information table 104A is a table that includes job information indicating the job queued in the queue of the message queue 103. The task status table 104B is a table that includes a status (progress) of the job indicated by the job information. The document processing request management unit 105 receives a job execution request from the front-end application 101 and writes job information of the received job in the job information table 104A. In addition, the document processing request management unit 105 puts (queues) the job received from the front-end application 101 in a queue of the message queue 103.

The worker W acquires, a job from the message queue 103. The job handled by the worker W is hereinafter also referred to as an assigned job. Further, the worker W acquires job information of the assigned job from the job information table 104A. Furthermore, the worker W acquires a processing subject file from the shared file storage 102 based on the acquired job information. After executing the assigned job for the processing subject file, the worker W stores a processing result file of the assigned job in the shared file storage 102.

Hereinafter, a description is given of an outline of a sequence of processing for executing an assigned job in the information processing system according to the present embodiment. When a job is submitted to the front-end application 101, the front-end application 101 stores a processing subject file in the shared file storage 102. Then, the front-end application 101 submits the job including a uniform resource locator (URL) of the processing subject file to the document processing request management unit 105.

The document processing request management unit 105 stores job information of the job submitted from the front-end application 101 in the job information management database 104 and queues the job in a queue of the message queue 103. For example, when a type of the job submitted from the front-end application 101 (hereinafter referred to as a job type) is a job type for converting an image to a portable document format (PDF) (image2pdf), the document processing request management unit 105 queues the job in a queue corresponding to the job type (image2pdf) among queues included in the message queue 103.

The worker W monitors (polls), among the queues of the message queue 103, a queue of the job type assigned to thereto (hereinafter referred to as an assigned job). Then, when an assigned job exists in the queue of the message queue 103, the worker W acquires job information of the assigned job from the job information table 104A. Further, the worker W acquires a processing subject file from the shared file storage 102 based on the acquired job information and executes the assigned job for the acquired processing subject file. At this time, the worker W writes a status of the assigned job (for example, what type of processing is executed by the worker W from when) in the task status table 104B. When the assigned job is completed, the worker W deletes the status of the assigned job from the task status table 104B. Furthermore, the worker W stores a processing result file of the assigned job in the shared file storage 102 and writes job information indicating a completion of the assigned job and the URL of the processing result file in the job information table 104A.

FIG. 2 is a block diagram illustrating an example of a configuration of the servers in the information processing system according to the first embodiment. Referring now to FIG. 2, a description is given of the configuration of the servers in the information processing system according to the present embodiment.

The information processing system according to the present embodiment includes the application server 201 including the front-end application 101, the front server 205 including the document processing request management unit 105, the queue server 203 including the message queue 103, the DB server 204 including the job information management database 104, the file server 202 including the shared file storage 102, the worker server WS1 including the workers W1-1 and W1-2, and the worker server WS2 including the workers W2-1 and W2-2. In the following description, the worker servers WS1 and WS2 are collectively referred to as worker servers WS unless particularly distinguished from each other.

The information processing system according to the present embodiment includes the two worker servers WS1 and WS2. This is because even if an abnormality occurs in one of the worker servers WS, the other worker server WS can continue a job. The system configuration is a so-called redundancy configuration. Similarly, each of the application server 201, the front server 205, the queue server 203, the DB server 204, and the file server 202 may be configured by a plurality of servers. In the present embodiment, the application server 201, the front server 205, the queue server 203, the DB server 204, the file server 202, and the worker server WS exist as virtual servers on a cloud service, but may be configured as physical servers. In each of the worker server WS, each of the plurality of workers W is activated as a process. The plurality of workers W may exist in one worker server WS.

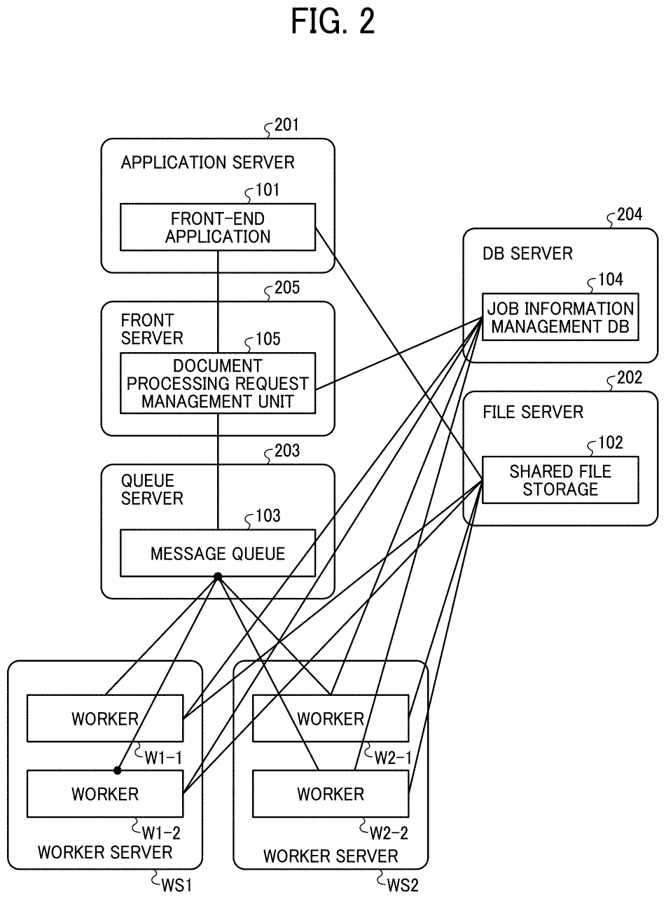

FIG. 3 is a table illustrating an example of a data configuration of a job information table in the information processing system according to the first embodiment. Referring now to FIG. 3, a description is given of the data configuration of the job information table 104A.

In the present embodiment, as illustrated in FIG. 3, the job information table 104A includes data items of a job identifier (ID), a user ID, a status, a submitted date and time, a job type, and a parameter in association with one another. The job ID is information identifying a job. The user ID is information identifying a user who submits the job. The status is information indicating a processing status of the job. The submitted date and time is information indicating a date and time when the job is submitted. The job type is information indicating a type (kind) of job processing. The parameter is information indicating a parameter used for processing the job.

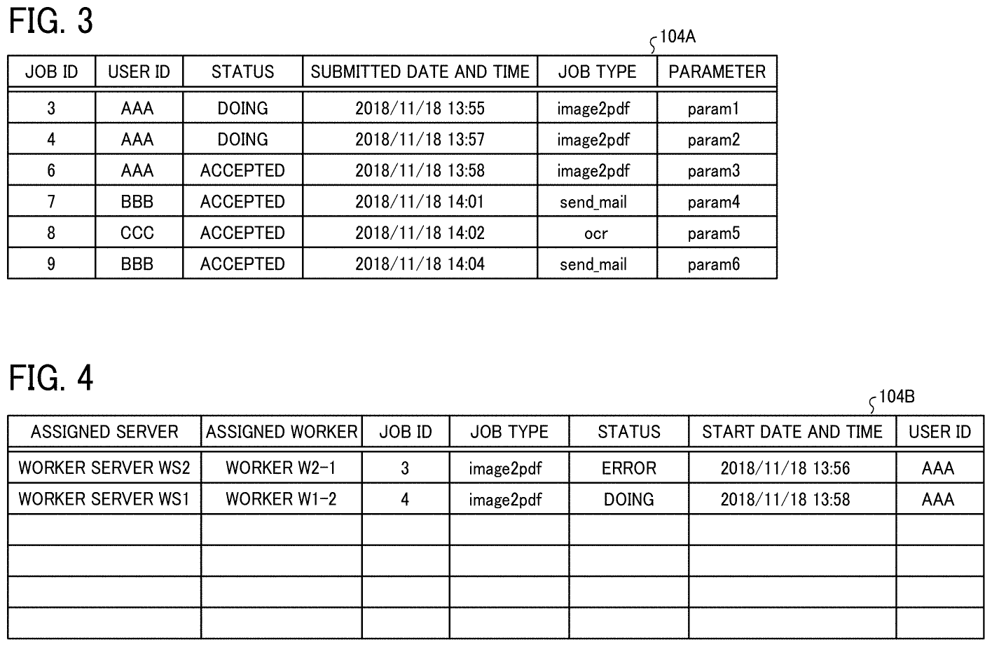

FIG. 4 is a table illustrating an example of a data configuration of a task status table in the information processing system according to the first embodiment. Referring now to FIG. 4, a description is given of the data configuration of the task status table 104B.

In the present embodiment, as illustrated in FIG. 4, the task status table 104B includes data items of an assigned server, an assigned worker, a job ID, a job type, a status, a start date and time, and a user ID in association with one another. The assigned server is information indicating the worker server WS that includes the worker W that executes an assigned job. The assigned worker is information indicating the worker W that executes the assigned job. The job ID is information identifying the assigned job. The job type is information indicating a type (kind) of processing of the assigned job. The status is information indicating a processing status of the assigned job. The start date and time is information indicating a date and time when the processing of the assigned job is started. The user ID is information identifying a user who submits the assigned job.

In the information processing system according to the present embodiment, when a library used by the worker W for executing an assigned job does not operate normally due to a failure of a memory, a process, a thread, or the like, or the library is frozen, another worker W having a normal library completes the assigned job without fail. In other words, the information processing system according to the present embodiment prevents a new job from being executed by the worker W having an abnormal library. As a result, a job that has failed and has no relief measure for recovering in a conventional technique can be successfully executed.

Specifically, when an error occurs in the assigned job, the worker W writes “ERROR” as the status of the assigned job among jobs included in the task status table 104B and returns the failed assigned job to the queue of the message queue 103. Further, the worker W returns the assigned job to the queue of the message queue 103 without executing the assigned job when the following conditions are satisfied. The status of the assigned job included in the task status table 104B indicates an error. The worker W (e.g., the worker W1-1 in FIG. 2) belongs to the same worker server WS that includes the worker W (e.g., the worker W1-2 in FIG. 2) that has executed the assigned job in which the error has occurred. The job type of the assigned job is the same job type of the job in which the error has occurred. Accordingly, even when the assigned job is not completed by a certain worker W, the assigned job is executed by another worker W capable of succeeding the assigned job. As a result, even when an error occurs in the assigned job, the assigned job in which the error has occurred can be recovered.

FIG. 5 is a sequence diagram illustrating an example of a sequence of processing for executing a job in the information processing system according to the first embodiment. Referring now to FIG. 5, a description is given of the sequence of processing for executing the job by the worker W2-1 in the information processing system according to the present embodiment.

For example, the worker W2-1 acquires an assigned job (for example, an assigned job having a job type “image2pdf”) from a queue of the message queue 103 (S521). In addition, the worker W2-1 checks whether or not the status of the acquired assigned job among jobs included in the task status table 104B indicates an error (S522). When the status of the acquired assigned job does not indicate an error, the worker W2-1 acquires job information of the assigned job from the job information table 104A (S523).

Then, the worker W2-1 acquires a processing subject file for executing the assigned job from the shared file storage 102 based on the acquired job information (S524). Then, the worker W2-1 starts the job (for example, conversion processing from an image to a PDF) for the acquired processing subject file (S525). At this time, if an error occurs in the assigned job due to a memory access violation or the like in a PDF library, the worker W2-1 writes “ERROR” as the status of the assigned job that the worker W2-1 of the worker server WS2 has executed among the jobs included in the task status table 104B (for example, the status corresponding to a job having a job ID “3” in the task status table 104B of FIG. 4) (S526). In addition, the worker W2-1 writes “ERROR” as the status of the assigned job among the jobs included in the job information table 104A (for example, the status corresponding to a job having the job ID “3” in the job information table 104A of FIG. 3) (S527). Further, the worker W2-1 returns the assigned job that has not been completed to the queue of the message queue 103 (S528).

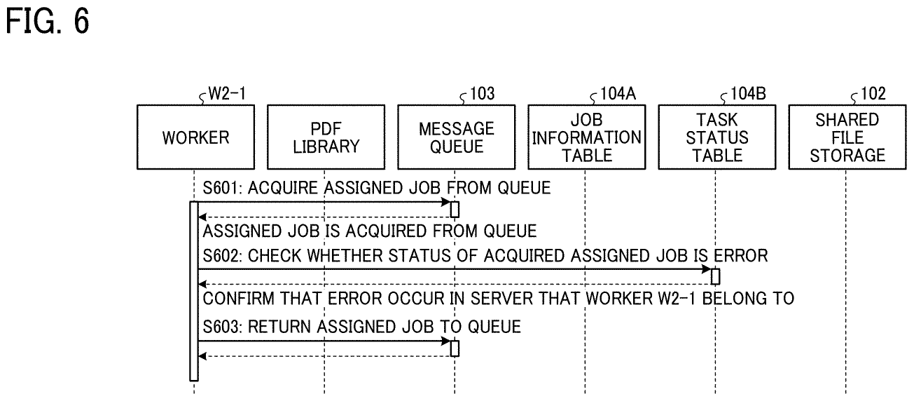

FIG. 6 is a sequence diagram illustrating an example of a sequence of processing for returning an assigned job to a queue of a message queue in the information processing system according to the first embodiment. Referring now to FIG. 6, a description is given of the sequence of the processing for returning the assigned job to the queue of the message queue 103 in the information processing system according to the present embodiment.

The worker W2-1 polls the queue of assigned jobs among queues of the message queue 103. Then, the worker W2-1 acquires the assigned job (S601), and checks whether or not the status corresponding to the job ID of the assigned job acquired from the queue indicates an error in the task status table 104B (S602). Assume that the status of the assigned job acquired by the worker W2-1 indicates an error (for example, the assigned job having the job ID “3”).

In a conventional information processing system, since the PDF library of the worker W2-1 is in a state in which the error has occurred, the same error is likely to occur when the worker W2-1 executes the assigned job having the job ID “3.” In the conventional information processing system, to prevent the worker W2-1 from repeating processing of the assigned job infinitely, the number of times of repeating the processing of the same assigned job is determined to be two times. In a case where the error occurs two times, a user is notified of the error of the assigned job and the worker W2-1 ends the processing of the assigned job.

On the other hand, in the present embodiment, in a case where the status checked in step S602 indicates an error, the worker W2-1 checks whether or not the worker server WS including the worker W corresponding to the status indicating the error is the worker server WS2 including the worker W2-1 in the task status table 104B. That is, the worker W2-1 determines whether or not the worker server WS including the worker W that has executed the assigned job having a status “ERROR” is the same worker server WS2 that includes the worker W2-1. Then, in a case where the worker server WS including the worker W corresponding to the status indicating the error is the same worker server WS2 that includes the worker W2-1, the worker W2-1 returns the acquired assigned job to the queue of the message queue 103 without executing the assigned job (S603).

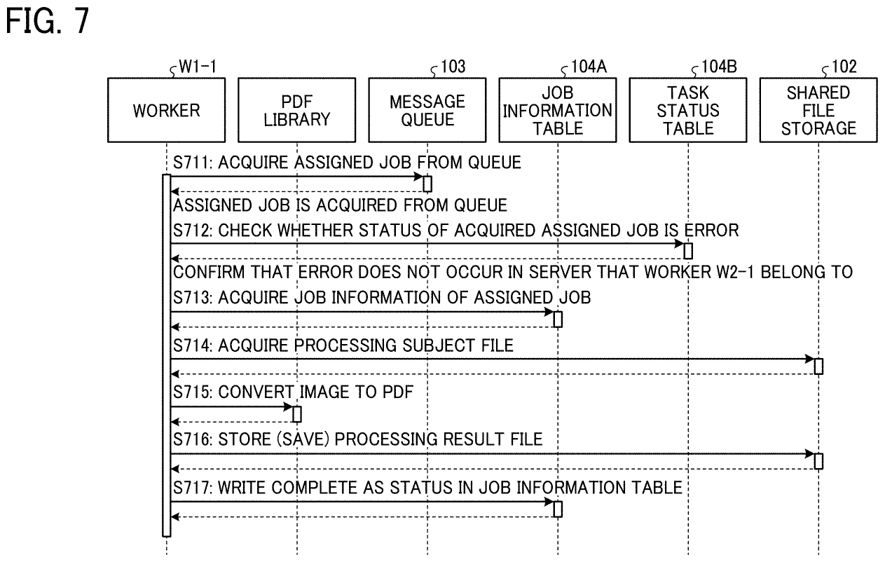

FIG. 7 is a sequence diagram illustrating an example of a sequence of processing by a worker for executing an assigned job in the information processing system according to the first embodiment. Referring now to FIG. 7, a description is given of the sequence of the processing for executing the job by the worker W1-1 in the information processing system according to the present embodiment.

The worker W1-1 acquires an assigned job (for example, an assigned job having a job type “image2pdf”) from a queue of the message queue 103 (S711). In addition, the worker W1-1 checks whether or not the status of the acquired assigned job among jobs included in the task status table 104B in FIG. 4 indicates an error (S712).

The status of the acquired assigned job (job ID “3”) indicates an error in the task status table 104B. However, since the worker server WS corresponding to the status indicating the error is not the same worker server WS1 that includes the worker W1-1, the worker W1-1 acquires job information of the assigned job from the job information table 104A (S713). Further, the worker W1-1 acquires a processing subject file from the shared file storage 102 based on the acquired job information (S714).

Then, the worker W1-1 executes the assigned job (for example, conversion processing from an image to a PDF) for the acquired processing subject file (S715). When the assigned job is completed, the worker W1-1 stores (saves) a processing result file of the assigned job in the shared file storage 102 (S716). In addition, the worker W1-1 writes “COMPLETE” as the status corresponding to the assigned job in the job information table 104A (S717).

As described above, according to the information processing system of the first embodiment, even when an assigned job is not completed by a certain worker W, the assigned job is executed by another worker W capable of succeeding the assigned job. As a result, even when an error occurs in the assigned job, the assigned job in which the error has occurred can be recovered.

### Second Embodiment

A second embodiment described below is an example in which, when a worker returns an assigned job to a queue of a message queue, the worker returns the assigned job at a top of the queue of the message queue. Hereinafter, descriptions of the configuration same as that of the first embodiment are omitted.

In the present embodiment, when a worker returns an assigned job to a queue of a message queue 103, the worker returns the assigned job at a top of the queue of the message queue 103. Thus, when an error occurs in the assigned job and the assigned job is returned to the queue of the message queue 103, an execution of the assigned job is not left behind and the time taken to complete the assigned job is reduced.

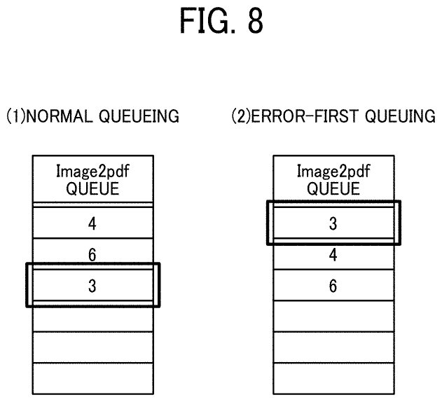

FIG. 8 is a schematic diagram illustrating an example of processing for returning an assigned job to a queue of a message queue by a worker in the information processing system according to the second embodiment of the present disclosure. In the comparative information processing system as illustrated in FIG. 8, or example, in S603 of FIG. 6, when the assigned job having the job ID “3” is returned to a queue of the message queue 103 (for example, a queue having a job type “image2pdf” of the message queue 103), the assigned job having the job ID “3” is returned after the jobs having the job ID “4” and “6” in the queue among the queues of the message queue 103. For this reason, the assigned job having the job ID “3” is executed after the jobs having the job ID “4” and “6”, and it takes time to complete the assigned job having the job ID “3.”

Therefore, according to the present embodiment, when the assigned job having the job ID “3” is returned to a queue of the message queue 103 (for example, a queue having a job type “image2pdf” in the message queue 103) in S603 of FIG. 6, the worker W2-1 returns the assigned job having the job ID “3” before the jobs having the job ID “4” and “6” in the queue among the queues in the message queue 103. That is, the assigned job having the job ID “3” is returned at a top of the queue in the message queue 103 as illustrated in FIG. 8.

As described above, according to the information processing system of the second embodiment, when an error occurs in an assigned job and the assigned job is returned to a queue of the message queue 103, an execution of the assigned job is not left behind and the time taken to complete the assigned job is reduced.

### Third Embodiment

A third embodiment described below is an example in which, based on a job information management database, when there is no executable job other than a job having an error status, a worker executes the job even if an error has occurred in execution of the job by another worker belonging to the same worker server that includes the worker that is about to execute the job. Hereinafter, descriptions of the configuration same as that of the embodiments described above are omitted.

In the present embodiment, based on a status of an assigned job stored in the task status table 104B in FIG. 4, when there is no job having a job type handled by a worker W other than the job in the error status, the worker W executes the job even if an error has occurred in execution of the job by another worker W belonging to the same worker server WS that includes the worker W that is about to execute the job. As a result, when a cause of the error that has occurred in the assigned job is eliminated in the worker W, the assigned job is normally executed. Thus, the assigned job is executed promptly and a waiting time for a user is shortened.

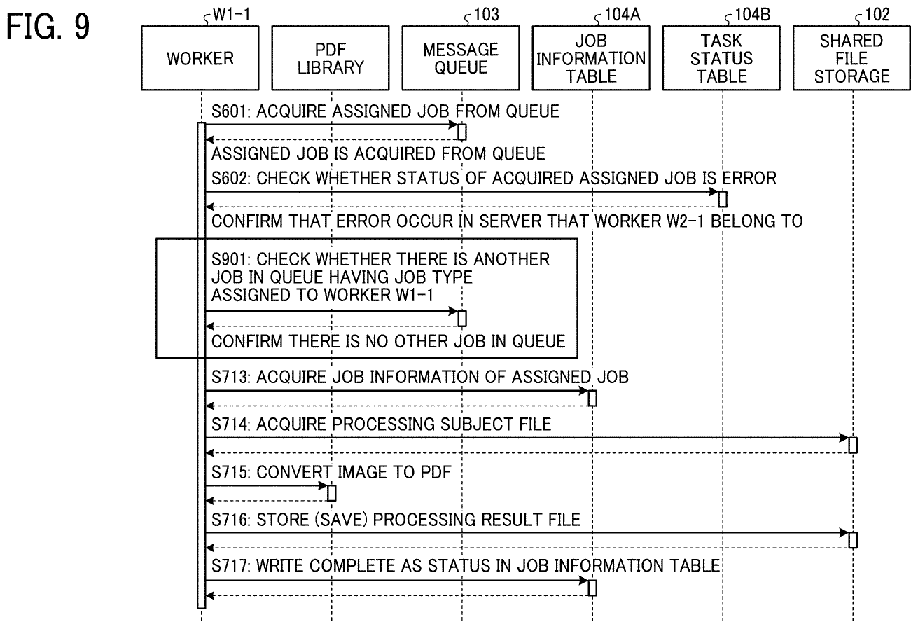

FIG. 9 is a sequence diagram illustrating an example of a sequence of processing for executing a job in the information processing system according to a third embodiment of the present disclosure. Referring now to FIG. 9, a description is given of the sequence of processing for executing the job in the information processing system according to the present embodiment. Hereinafter, descriptions of the processing same as that illustrated in FIGS. 6 and 7 are omitted.

In step S603 of FIG. 6, the status of the assigned job (the assigned job having the job type “image2pdf”) acquired from the task status table 104B indicates an error. In this case, when the worker W having executed the assigned job belongs to the same worker server WS that includes the worker W2-1, the worker W2-1 returns the acquired assigned job to the queue of the message queue 103 without executing the assigned job. However, there may be a case where there is no queue of other job types (for example, an optical character recognition (OCR)) handled by the worker W2-1 and there is only a queue having a job type that has caused an error (for example, a job having the job type “image2pdf”) in the message queue 103. In such a state, the worker W2-1 executes only returning the assigned job to the queue of the message queue 103, resulting in a decrease in job processing efficiency. On the other hand, if the error has occurred in the assigned job due to a temporary malfunction of the library of the worker W2-1, the library may be restored.

Therefore, in the present embodiment, when the status of the assigned job (image2pdf) acquired from the task status table 104B in FIG. 4 indicates an error and the worker W having executed the assigned job belongs to the same worker server WS that includes the worker W1-1, the worker W1-1 checks whether or not there is a queue of other job type that is assigned to the worker W1-1 (a job having the job type “OCR”) in the message queue 103 (S901).

Then, in a case where there is a queue of other job type that is assigned to the worker W1-1 in the message queue 103, the worker W1-1 returns the acquired assigned job to the queue of the message queue 103 without executing the assigned job as described in step S603 of FIG. 6. On the other hand, in a case where there is no queue of other job type that is handled by the worker W1-1 in the message queue 103, the worker W1-1 executes the assigned job on a trial basis as described in steps S713 to S717 of FIG. 7.

As described above, according to the information processing system of the third embodiment, when a cause of an error that occurs in an assigned job is eliminated in the worker W, the assigned job is normally executed. Thus, the assigned job is executed promptly and a waiting time for a user is shortened.

### Fourth Embodiment

A fourth described below embodiment is an example in which, based on error information stored in the job information management database, a worker successfully re-executes a job that is worth retrying. Hereinafter, descriptions of the configuration same as that of the embodiments described above are omitted.

In the present embodiment, the job information table 104A includes an error information table indicating an error of a job that is worth retrying and an error of a job that is not worth retrying (examples of error information). In this case, based on the error information table, a worker W re-executes only the job that is worth retrying. As a result, the job that is not worth retrying is prevented from being re-executed.

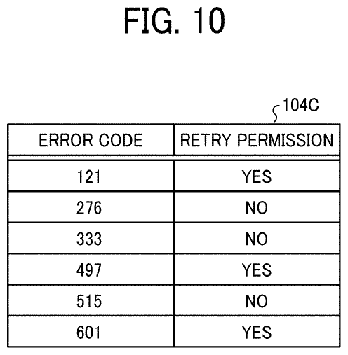

FIG. 10 is a table illustrating an example of a data configuration of the error information table included in the job information table of the information processing system according to the fourth embodiment of the present disclosure. The job that is not worth retrying is unlikely to be succeeded even if the job is re-executed. For example, in a case where a data file uniquely included in a library of a worker W is broken, the data file is not expected spontaneously restored unless a user reinstalls the data file.

In the present embodiment, the job information table 104A includes an error information table 104C as illustrated in FIG. 10. The error information table 104C is a table indicating an error of a job that is worth retrying and an error of a job that is not worth retrying. For example, as illustrated in FIG. 10, the error information table 104C is a table for associating an error code that is a code of an error occurred in execution of a job with a retry permission. As the retry permission, “YES” indicates an error of a job that is worth retrying and “NO” indicates an error of a job that is not worth retrying. Based on the error information table 104C, the worker W re-executes an assigned job having an error code “YES” and does not re-execute an assigned job having the error code “NO.”

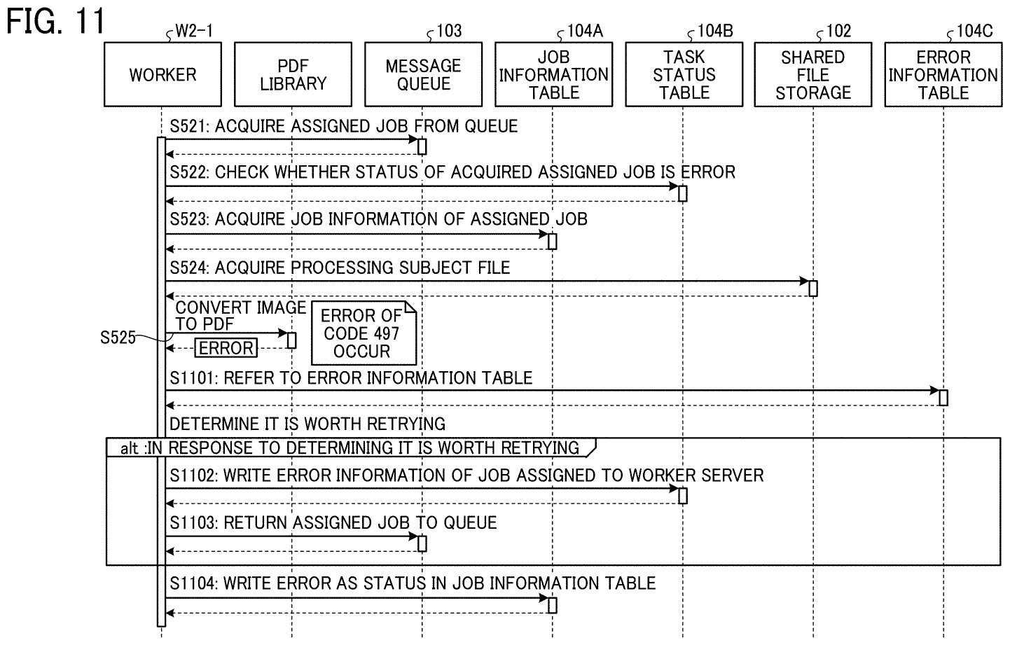

FIG. 11 is a sequence diagram illustrating an example of a sequence of processing for executing a job in the information processing system according to the fourth embodiment. Referring now to FIG. 11, a description is given of the sequence of the processing for executing the job in the information processing system according to the present embodiment. In the following description, processing different from the sequence of the job execution processing illustrated in FIG. 5 is described.

In the job execution processing illustrated in FIG. 5, when an error occurs in an assigned job due to a memory access violation or the like in the PDF library (S525), the worker W2-1 writes “ERROR” as the status of the assigned job corresponding to the job having the job ID “3” in the task status table 104B (S526). On the other hand, in the present embodiment, when an error occurs in the assigned job (S525), the worker W2-1 refers to the error information table 104C included in the job information table 104A and determines whether or not the retry permission corresponding to the error code of the occurred error indicates “YES” (S1101).

Then, when the retry permission corresponding to the error code of the occurred error (for example, the error code indicating “497”) indicates “YES”, that is, when the job in which the error has occurred is worth retrying, the worker W2-1 writes “ERROR” as the status corresponding to the assigned job having the job ID “3” in the task status table 104B because the job is likely to succeed when re-executed (S1102). Further, the worker W2-1 returns the assigned job being executed to the queue of the message queue 103 (S1103).

On the other hand, when the retry permission corresponding to the error code of the occurred error (for example, the error code indicating “515”) indicates “NO”, that is, when the job in which the error has occurred is not worth retrying, the worker W2-1 executes the processing of neither writing the status in the task status table 104B nor returning the assigned job to the queue of the message queue 103 because the assigned job is not likely to succeed when re-executed. Then, the worker W2-1 writes “ERROR” as the status corresponding to the job ID of the assigned job in the job information table 104A (S1104). Accordingly, another worker W is prevented from executing the job that is unlikely to succeed.

As described above, according to the information processing system of the fourth embodiment, a job that is not worth retrying is prevented from being re-executed.

### Fifth Embodiment

A fifth embodiment described below is an example in which, while a worker is polling a queue stored in a message queue, if there is no job having a job type handled by the worker other than a job having a status “ERROR,” the worker executes the same job in which the error has occurred for a preset test file. Then, when the job is executed successfully, the worker erases the error information in the status corresponding to the job. Hereinafter, descriptions of the configuration same as that of the embodiments described above are omitted.

In the present embodiment, when there is no job having a job type handled by the worker W other than a job having the status “ERROR” during polling queues stored in the message queue 103, the worker W executes the same job in which the error has occurred for a preset test file. Then, in a case where the job for the preset test file is executed successfully, the worker W erases the error information in the status corresponding to the job ID of the job in the task status table 104B. As a result, even if an error occurs in the assigned job in the worker W, the assigned job is executed in the worker server WS including the worker W.

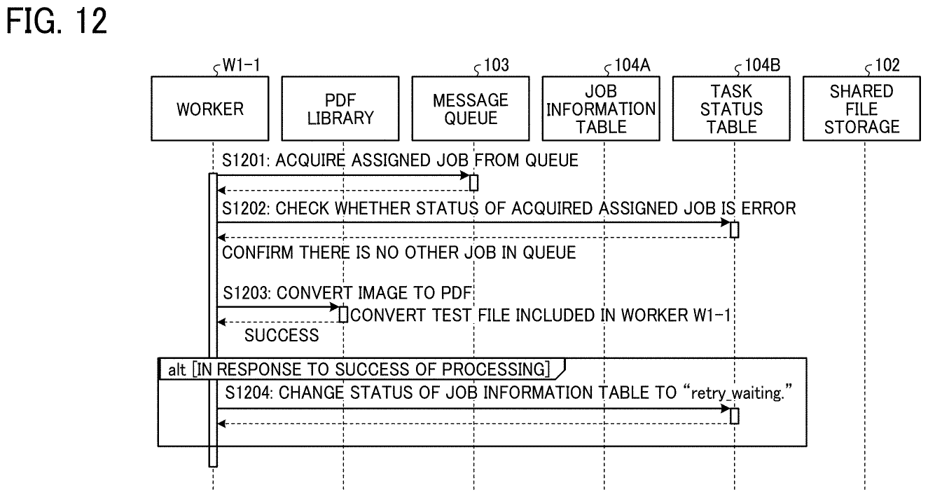

FIG. 12 is a sequence diagram illustrating an example of a sequence of processing for executing an assigned job for a test file in the information processing system according to the fifth embodiment of the present disclosure. When there is no job in a queue having a job type handled by the worker W1-1 (for example, OCR) during polling queues of the message queue 103, the worker W1-1 acquires a job of another job type that is handled by the worker W1-1 (for example, a job having a job type “image2pdf”) (S1201). Then, the worker W1-1 checks whether or not the status corresponding to the job ID of the acquired assigned job (for example, “image2pdf”) indicates an error in the task status table 104B (S1202).

In a case where the status of the acquired assigned job indicates an error, the worker W1-1 executes the assigned job (for example, a job having the job type “image2pdf”) for a preset test file (for example, a test file with a small file size that is installed when the worker is released) (S1203). When the assigned job for the preset test file is executed successfully, the worker W1-1 determines that the PDF library used for executing the assigned job (for example, a job having the job type “image2pdf”) is normalized. Then, the worker W1-1 changes the status corresponding to the assigned job to a status waiting a retry (“retry_waiting”) in the task status table 104B (S1204).

As described above, according to the information processing system of the fifth embodiment, even if an error occurs in an assigned job in a worker W, the worker server WS including the worker W executes the assigned job.

### Sixth Embodiment

A sixth embodiment described below is an example in which a worker restarts the process of the worker itself when an error occurs in an assigned job. Hereinafter, descriptions of the configuration same as that of the embodiments described above are omitted.

Many of errors in a PDF library used for executing a job of “image2pdf”, which is an example of an assigned job executed by a worker W, are errors caused by a temporary stop of a process being executed by the worker W or an exhaustion of a memory. These errors may be eliminated spontaneously or by an operating system (OS). However, among the errors in the PDF library, there is an error caused by an existence of a process executed by the worker W or a continuing use of the memory.

Therefore, in the present embodiment, when an error occurs in an assigned job, a worker W restarts the process of the worker W itself. As a result, the worker W is promptly normalized for executing the assigned job in which the error has occurred. Various methods for restarting the process of the worker W are provided. Among these methods, a method generally used is that the worker W itself detects an abnormality of the PDF library and ends the process by causing a restart script to restart the process. Alternatively, a process monitoring program installed in the worker W in advance may monitor a process and restart the process when an error has occurred in the process.

In the present embodiment, when an error occurs in an assigned job even if the process of a worker itself is restarted, the information processing system restarts the worker server WS including the worker. For example, in a case where a monitoring script used in a Zabbix operation or the like confirms that an abnormality of the worker W is not eliminated in a certain period of time, the worker W issues an instruction for restarting the OS of the worker server WS.

In the present embodiment, when an error occurs in an assigned job even if a worker server WS is restarted, that is, when the error of the assigned job is not eliminated in all workers W of the worker server WS that includes the worker W in which the error occurs in execution of the assigned job, the information processing system shuts down the worker server WS including the worker W by starting a new server instance. For example, when a PDF library is not normalized even when the worker server WS is restarted, it is highly probable that a part of the data of the PDF library itself is damaged. In this case, the worker W can be normalized by reinstalling the PDF library in the worker W. However, when an error occurs in a cloud system at night, it is difficult to deal with the error.

In a platform of a cloud service such as Amazon Web Service (AWS) and Microsoft Azure (Azure), a server instance in a normal state remains, and a function of duplicating the server instance and activating a new server instance is provided. Therefore, when an error of the worker W is detected by monitoring of the Zabbix operation or the like, the worker W, using the function of duplicating the server instance and activating a new server instance, activates the new server instance of the worker server WS and stops the old server instance of the worker server WS. Thus, even when an abnormality occurs at night, the execution of the assigned job is continued.

As described above, according to the information processing system of the sixth embodiment, a worker W is promptly normalized for executing an assigned job in which an error occurs.

Each of the functions of the described embodiments may be implemented by one or more processing circuits or circuitry. Here, the “processing circuit or circuitry” in the present disclosure includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules arranged to perform the recited functions.

The apparatuses or devices described in the above embodiments and modifications are just one example of plural computing environments that implement the embodiments disclosed herein. In some embodiments, each of the application server 201, the file server 202, the queue server 203, the DB server 204, and the front server 205 includes multiple computing devices, such as server clusters. The multiple computing devices are configured to communicate with one another through any type of communication link, including a network, a shared memory, etc., and perform the processing disclosed herein. Similarly, each of the worker server WS1 and the worker server WS2 may include multiple computing devices configured to communicate with one another.

The server 5 as an example of various servers is not limited to an information processing apparatus as long as the device has a communication capability. The server 5 as an example of various servers may be, for example, a projector (PJ), an interactive white board (IWB; an electronic white board having a blackboard function capable of mutual communication), an output device such as a digital signage, a head-up display (HUD) device, an industrial machine, an imaging device, a sound collecting device, a medical device, a network home appliance, an automobile (connected car), a laptop PC, a mobile phone, a smartphone, a tablet terminal, a game console, a personal digital assistant (PDA), a digital camera, a wearable PC, or a desktop PC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing system comprising:
a shared file storage area that stores, for each of a plurality of jobs, a processing subject file of the job and a processing result file of the job;
a job information management database that stores, for each of the plurality of jobs, job information of the job and a status of the job;
one or more servers including circuitry configured to receive an execution request of the job from a front-end application, store the job information of the job in the job information management database, and store the job in a message queue; and
one or more worker servers including a particular worker server, the particular worker server including a plurality of worker processors, the plurality of worker processors including a particular worker processor including worker circuitry configured to:
acquire a particular job of the plurality of jobs from the message queue; and
determine whether the particular job is in an error status, and
based on a determination that the particular job is in the error status, the worker circuitry is further configured to:
return the particular job to the message queue based on a determination that:
an error has been occurred in executing of the particular job by one or more of the plurality of worker processors, other than the particular worker processor, at the particular worker server; and
a job type of the particular job in the error status is the same job type assigned to the particular worker processor. 2. The information processing system according to claim 1, wherein, based on a determination that the particular job is not in the error status, the worker circuitry is further configured to:
acquire the job information of the particular job from the job information management database;
acquire the processing subject file of the particular job from the shared file storage area based on the job information of the particular job;
store the processing result file of the particular job in the shared file storage area after executing the particular job for the processing subject file of the particular job; and
in response to an error occurring in the particular job, write an error status as the status of the particular job in the job information management database.

3. The information processing system according to claim 1, wherein
the worker circuitry returns the particular job at a top of a queue of the message queue.

4. The information processing system according to claim 1, wherein the worker circuitry is further configured to determine whether there is any other job to be handled by the particular worker processor based on the status stored in the job information management database, and
in a case where there is no job to be handled by the particular worker processor except the particular job, the worker circuitry executes the particular job irrespective of whether an error has occurred in execution of the particular job by the one or more of the plurality of worker processors other than the particular worker processor.

5. The information processing system according to claim 2, wherein:
the job information management database further stores error information indicating whether the particular job is to succeed or fail in re-execution; and
the worker circuitry re-executes the particular job to succeed in re-execution based on the error information stored in the job information management database.

6. The information processing system according to claim 1, wherein:
the worker circuitry executes the particular job in the error status for a preset test file in the case there is no job to be handled by the particular worker processor except the particular job in the error status during polling queues stored in the message queue; and
erases the error status of the particular job in response to a success of the particular job for the preset test file.

7. The information processing system according to claim 4, wherein
the worker circuitry restarts an own process in response to an occurrence of an error in the particular job.

8. The information processing system according to claim 4, wherein
the worker circuitry restarts the particular worker server that includes the particular worker processor that has executed the particular job in response to the error occurring in the particular job.

9. The information processing system according to claim 4, wherein
the worker circuitry activates a new server instance and shuts down the particular worker server in a case where the error that has occurred in the particular job is not eliminated in all the plurality of worker processors belonging to the particular worker server that includes the particular worker processor that has executed the particular job in which the error has occurred.

10. An information processing apparatus including a plurality of worker processors including a particular worker processor, the particular worker processor including worker circuitry configured to:
acquire a particular job of a plurality of jobs from a message queue;
determine whether the particular job is in an error status; and
based on a determination that the particular job is in the error status, the worker circuitry is further configured to:
return the particular job to the message queue based on a determination that:
an error has been occurred in executing of the particular job by one or more of the plurality of worker processors, other than the particular worker processor, at the information processing apparatus; and
a job type of the particular job in the error status is the same job type assigned to the particular worker processor.

11. The information processing apparatus of claim 10, wherein, based on a determination that the particular job is not in the error status, the worker circuitry is further configured to:
acquire job information of a particular job from a job information management database;
acquire a processing subject file of the particular job from a shared file storage area based on the job information of the particular job;
store a processing result file of the particular job in the shared file storage area after executing the particular job for the processing subject file of the particular job; and
in response to an error occurring in the particular job, write an error status as a status of the particular job in the job information management database.

12. An information processing method, performed by a worker processor, comprising:
acquiring a particular job of a plurality of jobs from a message queue;
determining whether the particular job is in an error status; and
based on a determination that the particular job is in the error status, the method further comprising:
returning the particular job to the message queue based on a determination that:
an error has been occurred in executing of the particular job by one or more of a plurality of worker processors, other than a particular worker processor, at the information processing apparatus; and
a job type of the particular job in the error status is the same job type assigned to the particular worker processor.

13. The information processing method of claim 12, wherein, based on a determination that the particular job is not in the error status, the method further comprising:
acquiring job information of a particular job from a job information management database;
acquiring a processing subject file of the particular job from a shared file storage area based on the job information of the particular job;
storing a processing result file of the particular job in the shared file storage area after executing the particular job for the processing subject file of the particular job; and
in response to an error occurring in the particular job, writing an error status as a status of the particular job in the job information management database.
